(19) United States
(12) Patent Application Publication
(10) Pub. No.: US 2025/0364236 A1
(43) Pub. Date: Nov. 27, 2025

(54) Resonant CID for Sequencing of Oligonucleotides in Mass Spectrometry

(71) Applicant: DH Technologies Development Pte. Ltd., Singapore (SG)

(72) Inventors: Takashi BABA, Richmond Hill (CA); Kaoru KARASAWA, Tokyo (JP); Eva DUCHOSLAV, Toronto (CA)

(21) Appl. No.: 18/870,047

(22) PCT Filed: May 26, 2023
(86) PCT No.: PCT/IB2023/055446

§ 371 Date: Nov. 27, 2024

Related U.S. Application Data
(60) Provisional application No. 63/347,814, filed on Jun. 1, 2022.

(51) Int. Cl. H01J 49/00; H01J 49/42

(52) U.S. Cl. CPC H01J 49/005; H01J 49/0063; H01J 49/4225

(57) ABSTRACT

A method of dissociation of an oligonucleotide in a mass spectrometer includes introducing the oligonucleotides into an electrospray ionization source operated in a negative mode to cause deprotonation of said oligonucleotide for generating a negatively charged ion of said oligonucleotides, trapping said negatively charged oligonucleotide ions in linear radiofrequency (RF) ion traps with T bar electrodes, filling the linear ion trap with a buffer gas, and using a resonant dipole AC excitation signal applied to the T bar electrodes to resonantly excite the negatively charged oligonucleotide ions at secular frequencies thereof to cause selective fragmentation of said negatively charged oligonucleotide ions via collision with molecules of said buffer gas.

### RELATED APPLICATIONS

This application claims priority to U.S. provisional application No. 63/347,814 filed on Jun. 1, 2022, entitled “Resonant CID for Sequencing of Oligonucleotides in Mass Spectrometry,” which is incorporated herein by reference in its entirety.

### TECHNICAL FIELD

The present disclosure relates to methods and systems for performing mass spectrometry and in particular mass spectrometric analysis of oligonucleotides as well as mass spectrometers that implement such methods and more particularly to such mass spectrometers utilizing collision induced dissociation (CID) for fragmentation of analytes and in particular oligonucleotides.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis. Generally, a mass spectrometer includes an ion source, an analyzer, and a detector. The ion source converts a test sample into gaseous ions, the mass analyzer separates (or mass analyzes) the gaseous ions based on their m/z ratios, and the detector detects the separated ions. One or more ion isolation devices are often installed between the ion source and the analyzer to isolate the precursor ions. Further, one or more dissociation devices are often installed between the isolation device and the analyzer to dissociate the isolated precursor ions for tandem mass spectrometry.

A mass spectrometer can employ collision induced dissociation (CID) to cause the fragmentation of large analytes (e.g., oligonucleotides, DNA, RNA, etc.) into smaller fragment ions. These smaller fragment ions can then be mass analyzed and quantified based on their m/z ratios.

### SUMMARY

Aspects of the present disclosure address the problems disclosed herein and/or others.

In one aspect, a method of dissociation of an oligonucleotide in a mass spectrometric analysis of the oligonucleotide includes, introducing the oligonucleotide into an electrospray ionization source operated in a negative mode to cause deprotonation of said oligonucleotide for generating a negatively charged ion of said oligonucleotide, trapping said negatively charged oligonucleotide ion in a radiofrequency (RF) ion trap containing a buffer gas, and using a resonant AC excitation signal to resonantly excite the negatively charged oligonucleotide ion at a secular frequency thereof to cause selective fragmentation of the negatively charged oligonucleotide ion via collision with molecules of the buffer gas. In some embodiments, the oligonucleotide includes at least 10, 15, 20, 25, or more nucleotides, e.g., up to 100 nucleotides.

In some embodiments, the RF ion trap can include a plurality of rods that are arranged in a multipole configuration. By way of example, and without limitation, the RF ion trap can include a linear RF ion trap having four rods that are arranged in a quadrupole configuration and further include a pair of AC electrodes each positioned in a gap between two of the RF rods so as to allow generating the AC excitation signal via application of an AC dipolar excitation voltage across the AC electrodes. In some embodiments, the RF ion trap includes a branched RF ion trap having two sets of four L-shaped electrodes that are positioned relative to one another so as to provide a longitudinal branch and a transverse branch extending, respectively, along a longitudinal and a transverse axis. The RF ion trap can further include a pair of opposed T-bar electrodes that is positioned between said L-shaped electrodes along one of the longitudinal and the transverse axis and to which a DC negative voltage is applied to bias the oligonucleotide ion to the channel positioned along the other axis, and wherein a dipolar AC voltage is applied to the L-shaped electrodes so as to generate said AC resonant excitation signal within the channel into which the oligonucleotide ions is biased.

In some embodiments, the RF ion trap further includes a first and a second pair of opposed T-bar electrodes, wherein each pair is positioned between the L-shaped electrodes such that one pair extends along the longitudinal axis and the other pair extends along the transverse axis, wherein a DC bias voltage is applied to the first pair of T-bar electrodes relative to the L-shaped electrodes with the same polarity as that of the oligonucleotide ion and wherein an AC voltage is applied to the second pair of opposed T-bar electrodes in a dipolar manner to generate the AC excitation signal and no DC bias voltage is applied to the second pair of the T-bar electrodes. The resonant AC voltage signal can be applied during introduction of the oligonucleotide ion into said RF ion trap or can be applied after introduction of the oligonucleotide ion into said RF ion trap. Furthermore, a frequency and an amplitude of RF voltages applied to said ion trap can be configured to allow trapping ions with m/z ratios within a target range containing the m/z ratio of said oligonucleotide ion and the AC excitation signal can be configured to have a frequency that matches a secular frequency of the trapped oligonucleotide ion.

In another aspect, a resonant ion dissociation device for use in a mass spectrometer is disclosed, which includes a chamber containing a buffer gas, a first and a second set of L-shaped rods arranged in a multipole configuration and positioned relative to one another to generate a longitudinal branch extending from an inlet for receiving a plurality of precursor ions to an outlet through which fragments of the precursor ions can exit the ion dissociation device and comprising an upstream and a downstream longitudinal portion defined by said first and said second set of rods, respectively, and a transverse branch that intersects the longitudinal branch to form an interaction region between the upstream and the downstream portions. The first and second rod sets are configured for application of RF voltages thereto. The resonant dissociation device includes a first pair of T-bar electrodes each having a base portion and at least one radial portion extending from the base portion, where the first pair of T-bar electrodes is positioned relative to the longitudinal branch such that said at least one radial portion thereof extends partially into said longitudinal branch. The first pair of T-bar electrodes is configured such that application of an AC resonant voltage across thereof at a frequency corresponding to a secular oscillation frequency of at least a portion of the precursor ions generates an AC excitation field for causing radial excitation of the precursor ions so as to cause selective fragmentation of at least a portion thereof via collision with molecules of the background gas, thereby generating a plurality of fragment ions. The resonant dissociation device further includes a second pair of T-bar electrodes each having a base portion and at least one radial portion extending from the base portion, where the second pair of T-bar electrodes is positioned relative to the first and second rod sets such that the radial portion of each of the T-bar electrodes of the second pair extends partially into said transverse branch. The second pair of T-bar electrodes is configured such that application of a DC bias voltage across said second pair biases the precursor ions towards at least one of said longitudinal upstream and downstream portions.

In some embodiments, the first pair of T-bar electrodes comprises two radial portions extending from said base portion such that one of said radial portions extends partially into said upstream longitudinal portion and the other radial portion extends partially into said downstream longitudinal portion. In some embodiments, the second pair of T-bar electrodes is biased oppositely relative to a charge of the precursor ions.

In yet another aspect, an ion dissociation device for use in a mass spectrometer is disclosed, which includes a chamber containing a buffer gas, a plurality of rods arranged in a multipole configuration to generate a linear passageway therebetween extending from an inlet for receiving a plurality of precursor ions to an outlet through which fragments of said precursor ions can exit the passageway, where the rods are configured for application of RF voltages thereto. A pair of opposed T-bar electrodes is positioned between the rods such that application of a resonant AC voltage across said T-bar electrodes generates a resonant excitation AC signal for resonantly exciting at least a portion of the precursor ions so as to cause selective fragmentation thereof via collision with molecules of the buffer gas. In some embodiments the multipole configuration of the rods includes a quadrupole configuration.

In yet another embodiment, a mass spectrometer is disclosed, which includes an ion source for receiving a sample and ionizing one or more analytes of the sample to generate a plurality of analyte ions, and a mass filter positioned downstream of the ion source for receiving the analyte ions and selecting a portion of those ions having m/z ratios in a target range as a plurality of precursor ions. A resonant ion dissociation device is positioned downstream of the mass filter to receive the precursor ions and provide resonant excitation of the precursor ions to cause fragmentation thereof via collision with a buffer gas contained within the ion dissociation device. Further, a mass analyzer is positioned downstream of the resonant ion dissociation device for receiving the fragment ions and generating mass spectral data associated with the fragment ions, where the resonant ion dissociation device comprises a chamber, which contains a buffer gas, a plurality of rods arranged in a multipole configuration to generate a linear passageway therebetween extending from an inlet for receiving a plurality of precursor ions to an outlet through which fragments of the precursor ions can exit the passageway, where the rods are configured for application of RF voltages thereto. A pair of opposed T-bar electrodes is positioned between the rods such that application of a resonant AC voltage across the T-bar electrodes generates a resonant excitation AC signal for resonantly exciting at least a portion of the precursor ions so as to cause selective fragmentation thereof via collision with molecules of said buffer gas.

In some embodiments, a mass spectrometer according to the present teachings includes an electrospray ion source configured to receive a sample and ionizing at least a portion thereof, and a branched RF ion trap having a first and a second set of L-shaped rods that are arranged in a multipole configuration and positioned relative to one another to generate a longitudinal passageway extending from an inlet for receiving a plurality of precursor ions to an outlet through which fragments of the precursor ions can exit the ion trap and comprising an upstream and a downstream longitudinal portion defined by the first and the second set of rods, respectively, and a transverse passageway that intersects the longitudinal passageway to form an interaction region between the upstream and the downstream portions. An RF voltage source is configured to apply RF voltages to the first and second rod sets. A first pair of T-bar electrodes each having a base portion and at least one radial portion extending from the base portion is positioned relative to at least one of said first and second longitudinal portions such that said at least one radial portion extends partially into said at least one longitudinal portion, where the first pair of T-bar electrodes is configured such that application of an AC resonant voltage across said pair at a frequency corresponding to a secular oscillation frequency of at least a portion of the precursor ions generates an AC excitation field for causing radial excitation of the precursor ions so as to cause selective fragmentation of at least a portion thereof via collision with a background gas within the ion trap, thereby generating a plurality of fragment ions. The mass spectrometer can further include a second pair of T-bar electrodes each having a base portion and at least one radial portion extending from the base portion, where the second pair of T-bar electrodes is positioned relative to the first and the second rod sets such that the radial portion of each of the T-bar electrodes of the second pair extends partially into a portion of said transverse passage. Further the second pair of T-bar electrodes is configured such that application of a DC bias voltage across said second pair biases said precursor ions towards at least one of said longitudinal upstream and downstream portions.

In some embodiments, the mass spectrometer further includes an RF voltage source for generating said RF voltages and a DC voltage source for generating said DC bias voltage. Further, the mass spectrometer can include a controller in communication with the RF and DC voltage sources for controlling those voltage sources for application of requisite RF and DC voltages to the multipole rods of the ion trap and the T-bar electrodes for performing a method of mass spectrometric analysis according to the present teachings.

### BRIEF DESCRIPTION OF THE DRAWINGS

Aspects of the present disclosure may take form in various components and arrangements of components, and in various steps and arrangements of steps. The drawings are only for illustration purpose of preferred embodiments of the present disclosure and are not to be considered as limiting.

Features of embodiments of the present disclosure will be more readily understood from the following detailed description take in conjunction with the accompanying drawings in which:

a. FIG. 1 schematically illustrates a mass spectrometer in accordance with an exemplary embodiment;

FIGS. 2A-2D schematically depict L-shaped electrodes and T-bar electrodes in accordance with an exemplary embodiment;

FIG. 3 schematically illustrates L-shaped electrodes and T-bar electrodes in accordance with an exemplary embodiment;

FIG. 4 illustrates an oscillating ion in accordance with an exemplary embodiment;

FIG. 5 schematically illustrates another mass spectrometer in accordance with an exemplary embodiment;

FIG. 6 schematically illustrates a collision cell employed in a mass spectrometer in accordance with an exemplary embodiment;

FIGS. 7 and 8 schematically illustrate electrodes for use in a collision cell of a mass spectrometer in accordance with an exemplary embodiment;

FIG. 9 is a flow chart depicting various steps in a method of dissociating an oligonucleotide in a mass spectrometer in accordance with an exemplary embodiment; and

FIG. 10 schematically depicts a computer system in accordance with an exemplary embodiment.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed at any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The present disclosure generally relates to methods for performing mass spectrometry and mass spectrometers configured to implement such methods. As noted above, a mass spectrometer can employ collision induced dissociation (CID) to fragment large precursor ions (also referred to as analyte ions), e.g., oligonucleotides, DNA, RNA, etc. into smaller fragment ions. In particular, CID may be useful in sequencing DNA and/or RNA. In these types of mass spectrometers, a supplied analyte is ionized. The precursor ions (also referred to as analyte ions) are accelerated and injected into a collision chamber in which the analyte ions collide with molecules of a neutral buffer gas (e.g., neon, krypton, helium, nitrogen, argon) disposed therein. These collisions excite the vibrational states of the precursor analyte ions, which can result in their dissociation. After dissociation, some fragments may still have a sufficient kinetic and/or vibrational energy that could induce a second dissociation thereof. In the second dissociation, larger fragments generated by the first dissociation event can be dissociated again to yield smaller internal fragments. It is typically difficult to trace back the smaller internal fragments to their position within the precursor sequence (i.e., within the supplied analyte) as they typically are not unique and have therefore limited value for an unambiguous determination of a position of the partial nucleotide sequences needed for the total sequence characterization. Generally, short 5′ and 3′ terminal fragments can be identified in CID spectra, but information regarding a middle portion of the sequence is often missing.

In one aspect, the present disclosure relates to methods for performing mass spectrometry and mass spectrometers that may be utilized to practice such methods. In embodiments, these methods include trapping a plurality of negatively charged analyte ions (also referred to as “precursor ions”) within an ion trap and applying an AC voltage to an electrode in communication with the ion trap. The frequency of the applied AC voltage may be equal to a secular frequency of an analyte ion of interest (e.g., an analyte ion with a given m/z ratio) which causes the analyte ion of interest to resonantly oscillate. Such oscillating analyte ions collide with a neutral buffer gas disposed in the trap. These collisions can cause at least a portion of the oscillating ions to dissociate, thereby generating a plurality of fragment ions (herein also referred to as “fragments” for brevity). The produced fragments have a different m/z ratio than their respective precursor ions and therefore have a different secular frequency from the precursor ions, which prevents their resonant excitation and their subsequent fragmentation via the applied AC voltage.

Referring now to FIG. 1, a mass spectrometer 100 is shown in accordance with an exemplary embodiment. In this embodiment, the mass spectrometer 100 includes an electrospray ion source 102 operating in a negative ionization mode to cause deprotonation of at least one analyte of a received sample, thereby generating a plurality of negatively charged precursor ions 104. More specifically, the ion source 102 is in communication with a sample holder (not shown), which supplies precursor analytes (e.g., oligonucleotides) to the ion source 102 in which the precursor analytes undergo ionization to generate a plurality of negatively charged precursor ions 104.

The mass spectrometer 100 also includes a vacuum chamber 106 that is in communication with the ion source 102. The precursor ions 104 travel in the direction of arrow 108 and enter the vacuum chamber 106 via an IQ0 lens 110. In the vacuum chamber 106, the precursor ions 104 pass through a Q0 region 112, which includes an ion guide. In this embodiment, the ion guide includes four rods 114 (only two of which are shown in FIG. 1) that are arranged in a quadrupole configuration. The ion guide section 106 can have multiple ion guides in multiple vacuum chambers for multiple stage differential pumping.

The mass spectrometer 100 further includes an RF voltage source 116, a DC voltage source 118, and an AC voltage source 120 that are each under operation of a controller 122. The RF voltage source 116 can apply RF voltages to the rods 114 so as to generate an electromagnetic field. The electromagnetic field, in combination with gas dynamics, can focus the precursor ions 104 into an ion beam for transmission to downstream components of the mass spectrometer.

The precursor ions 104 continue propagating in the direction of arrow 108 and enter a vacuum chamber 124 via an IQ1 ion lens 126. Once within the vacuum chamber 124, the precursor ions 104 pass through a Q1 region 128 that is disposed within the vacuum chamber 124. The Q1 region 128 includes a Brubaker lens (or stubby lens) 130, a mass filter 132, and a stubby lens 134. The stubby lens 130 is positioned upstream from the mass filter 132 and the stubby lens 134 is positioned downstream from the mass filter 132. The mass filter 132 includes a plurality of rods 136 that are arranged in a multipole configuration. More specifically, in this embodiment, the mass filter 132 includes four rods 136 arranged in a quadrupole configuration. The mass filter 132 can be operated as an RF/DC quadrupole mass filter to select precursor ions having an m/z ratio of interest or m/z values within a range of interest.

The stubby lens 130 focuses charged precursor ions 104 exiting the vacuum chamber 106 into the mass filter 132. By way of example, the controller 122 operates the RF voltage source 116 and the DC voltage source 118 to provide the rods 136 of the mass filter 132 with RF/DC voltages suitable for operation in a mass-resolving mode. The application of RF voltages and resolving DC voltages to the rods 136 provides radial confinement of the precursor ions 104 and further allows selecting ions with an m/z ratio of interest or within a range of m/z ratios of interest to pass through the mass filter 132. The stubby lens 134 further focuses the precursor ions 104 into a resonant ion dissociation device 138 according to an embodiment of the present teachings, via an IQ2 lens 140.

With further reference to FIGS. 1-3, the resonant ion dissociation device 138 includes a collision chamber 144 in which an ion trap 144 is disposed. The ion trap 144 is defined by first L-shaped electrodes 146 and second L-shaped electrodes 148 (also referred to as L-shaped rods 146 and 148 respectively) that are axially separated from one another, pole electrodes 150 and 152 (e.g., a lens electrode), the lens 140 and optionally an exit electrode 154. At the center of the ion trap 144 is reaction region 155. While FIG. 1 shows the mass spectrometer 100 as including the electrode 160, in other embodiments the electrode 160 may be omitted.

In this embodiment, the first L-shaped electrodes 146 and second L-shaped electrodes 148 include four electrodes (only two of which are shown in FIG. 1) that are arranged in a quadrupole configuration and are axially separated from one another to provide the ion reaction region 155 therebetween. The first L-shaped electrodes 146 and second L-shaped electrodes 146 form an axial pathway (in the direction of arrow 108) through which the precursor ions 104 may pass. Further, the arrangement of the first L-shaped electrodes 146 and second L-shaped electrodes 148 forms a transverse pathway that is perpendicular to the axial pathway. The ion trap 144 formed by the first L-shaped electrodes 146 and second L-shaped electrodes 148 may be referred to as a “branched ion trap.” Each of the four branch portions has a linear quadrupole configuration, which works as a linear RF quadrupole ion trap. In this embodiment, the pseudo potential in the branches can be harmonic or semi harmonic.

The RF voltage source 116 and the DC voltage source 118 operating under control of the controller 122 supply voltages to the L-shaped electrodes 146 and 148 which trap the negatively charged precursor ions 104 within the ion trap 144. In this embodiment, since the first L-shaped electrodes 146 and second L-shaped electrodes 148 are supplied with an RF voltage, the ion trap 144 may be referred to as a “branched RF ion trap.”

The electrode 150 and the electrode 152 are positioned in proximity of an opening of the transverse pathway defined by the first L-shaped electrodes 146 and second L-shaped electrodes 148. The DC voltage source 118 can be used to apply a DC voltage to the electrodes 150 and 152 so as to maintain the electrodes 150 and 152 at an electric potential that would inhibit the negatively charged precursor ions 104 (e.g., oligonucleotides) and product ions from leaking out of the ion trap 144 via the transverse pathway. The AC voltage source 120 under control of the controller 122 supplies an AC voltage to the electrode 154 which generates a pseudopotential barrier that retains the negatively charged precursor ions 104 within the collision chamber 142. As will be discussed in further detail herein, fragment ions of interest (e.g., fragment ions having a certain m/z ratio) can overcome the AC pseudopotential barrier to exit the collision chamber 142.

The mass spectrometer 100 includes a gas reservoir 156 that is in communication with the collision chamber 142. The gas reservoir 156 supplies a neutral buffer gas (e.g., neon, krypton, helium, nitrogen, argon, etc.) to the collision chamber 142 via an inlet 158.

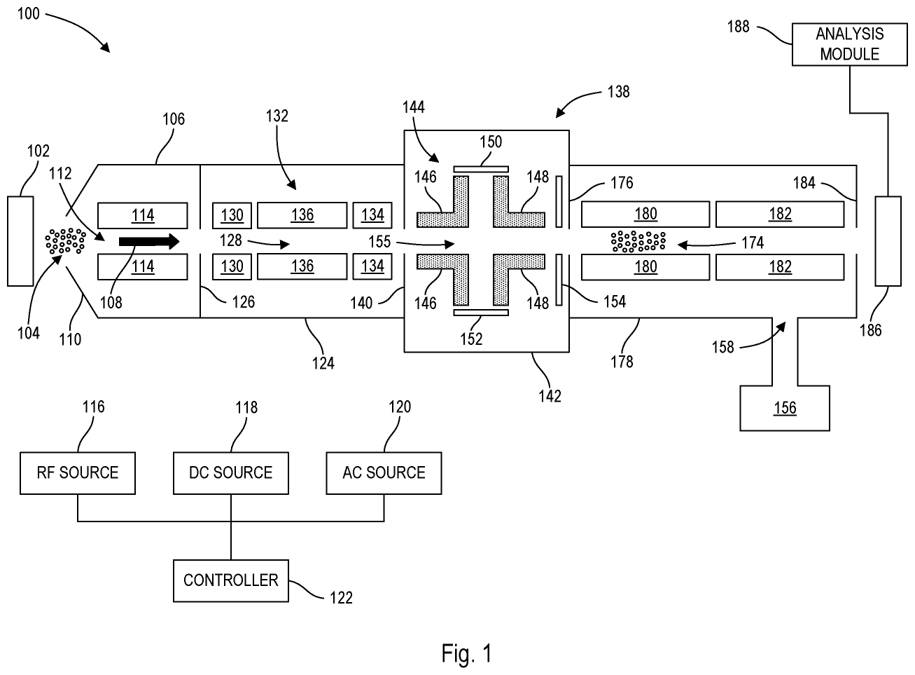

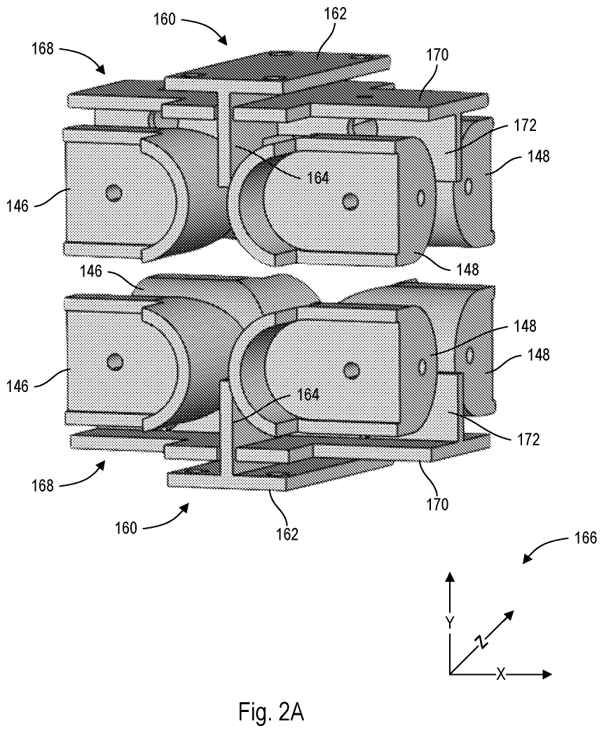

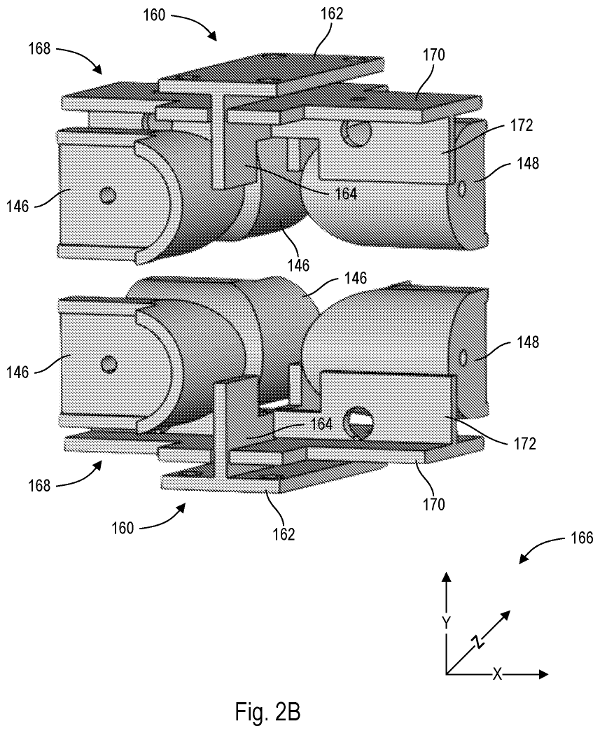

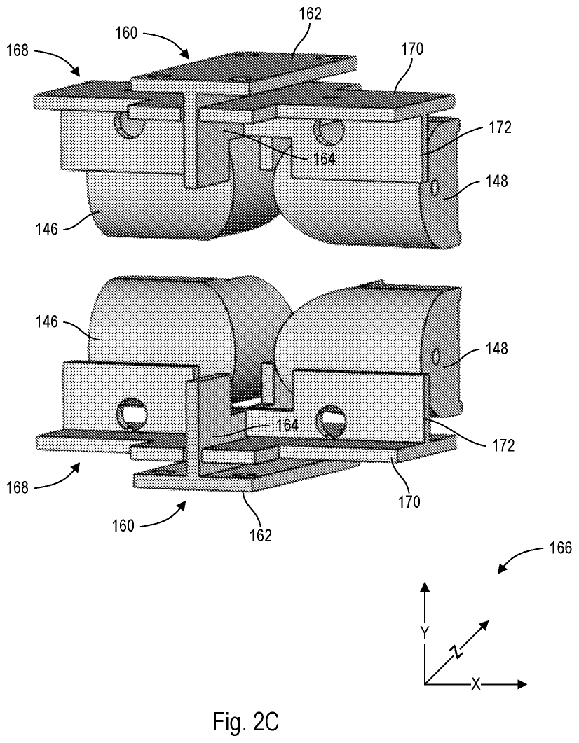

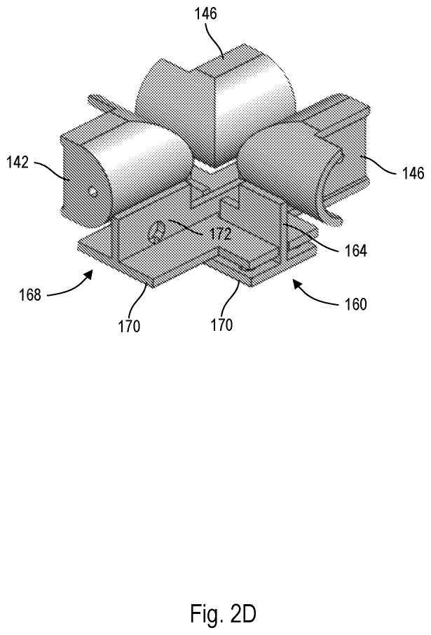

With particular reference to FIGS. 2A-2D the resonant ion dissociation device 138 further includes two T-shaped electrodes 160 (also referred to as eTBars) each positioned on opposite ends of the transverse pathway. Both of the T-shaped electrodes 160 include a base 162 and a stem 164 that extends vertically from and perpendicular to the base 162. The stems 164 extend within a gap between a first set of L-shaped electrodes 146 and a second set of L-shaped electrodes 148. The stems 164 also extend along a Z-axis of the standard Cartesian plane 166 such that the stems 164 are perpendicular to the longitudinal pathway.

The resonant ion dissociation device 138 also includes two T-shaped electrodes 168 (also referred to as iTBars) each positioned on opposite ends of the transverse pathway. Like the T-shaped electrodes 160, the T-shaped electrodes 168 include a base 170 and a stem 172 that extends vertically from and perpendicular to the base 170. The stems 172 extend within a gap between two first L-shaped electrodes 146. The stems 172 also extend along an X-axis of the standard Cartesian plane 166 such that the stems are parallel to the longitudinal pathway.

During operation of the mass spectrometer 100, the DC voltage source 118 supplies a DC bias voltage to the IQ2 lens 140. The DC bias voltage facilitates movement of the precursor ions 104 into the ion trap 144 of the resonant ion dissociation device 138. When the precursor ions 104 are within the ion trap 144, the DC voltage source 118 supplies a DC voltage to the T-shaped electrodes 160 such that the T-shaped electrodes 160 (and therefore a region between the T-shaped electrodes 160) are negatively biased relative to L-shaped electrodes 146 and 148.

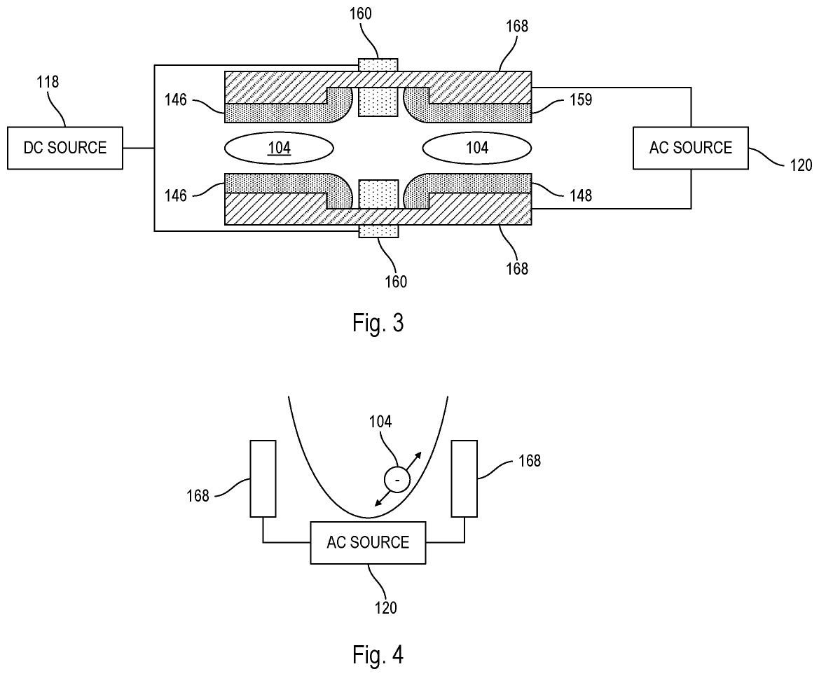

As depicted in FIG. 3, this bias voltage repels the negatively charged precursor ions 104 into downstream and upstream regions of the longitudinal pathway such that the negatively charged precursor ions 104 are between T-shaped electrodes 168. For example, in one embodiment, a negative DC voltage of about −10V˜−30V is applied to the T-shaped electrodes 160 such that the electrodes 160 produce a potential barrier of about 1.8V for biasing the negatively charged ions into the upstream and downstream portions of the longitudinal channel of the ion trap. The appropriate value of the negative DC bias voltage depends on the height of the stems of the eTBar electrodes 160.

Furthermore, the AC voltage source 120 operating under control of the controller 122 supplies a supplemental AC voltage to the T-shaped electrodes 168 to cause resonant excitation of the precursor ions within the ion trap. In this configuration, a dipolar AC field is applied to the precursor ions 104 in a region between the T-shaped electrodes 168. In this embodiment, the AC excitation field is applied to the precursor ions 104 in the downstream and upstream regions of the longitudinal pathway, where the precursor ions oscillator within a near harmonic pseudopotential.

As depicted in FIG. 4, the ion trap RF field creates a harmonic pseudo potential in which the excited ions oscillate at a secular frequency. When the frequency of the AC field is matched to the secular frequency of a given precursor ion 104, the precursor ion 104 begins to resonantly oscillate and gain kinetic energy. The secular frequency of a precursor ion can be determined according to Equation 1:

$$ω = \sqrt{2} \frac{\vert Ze \vert {V}_{rf}}{{mr}_{0}^{2} Ω} \qquad Eq . ( 1 )$$

wherein w is the secular frequency of a precursor ion, Ze is the charge of the precursor ion, V_{rf} is peak-to-peak amplitude of the applied RF voltage, m represents the mass of the precursor ion and r₀² represents the square of the radial distance between the rods of the ion trap, and Ω is the angular frequency of the applied RF voltage. The frequency of the AC field may be selected to match the secular frequency of the oscillating precursor ion 104 and therefore selectively excite the precursor ion. Furthermore, a longitudinal extent of the AC field may be adjusted by changing a length of a stem 172 of the T-shaped electrodes 168.

The oscillating precursor ions 104 collide with molecules of the buffer gas disposed within the collision chamber 142. Since the resonantly excited precursor ions 104 have a higher kinetic energy 104 they are more likely to fragment into fragment ions 174. Furthermore, the fragment ions 174 have a different secular frequency than the precursor ions 104. As such, the applied AC voltage cannot resonantly excite the fragment ions 174 and the fragment ions cannot be excited to undergo another fragmentation upon collision with molecules of the buffer gas.

Returning to FIG. 1, The inlet lens electrode 140 and the exit lens electrode 176 are biased negatively to retain the precursor ions and the fragment ions during the AC excitation within the ion trap. Once the resonant AC is applied for a duration to induce enough fragment ions, the exit lens electrode 154 is opened. Or the fragment ions of interest (e.g., fragment ions with a given m/z ratio or fragment ions with a m/z ratio within a given range) overcome the AC pseudopotential barrier generated by the optional electrode 154 and pass through the aperture of an IQ2 lens 176 to enter a downstream Q2 collision cell 178.

In this embodiment, the Q2 collision cell 178 includes a first set of rods 180 and a second set of rods 182. In this embodiment, the first set of rods 180 and the second set of rods 182 each include four rods (only two of which are shown in FIG. 1) arranged in a quadrupole configuration. The controller 116 operates the RF voltage source 118 to supply RF voltages to the rods 180 and 182 so as to generate an RF electric field for providing radial confinement of the ions in proximity of the central axis of the rods 180 and 182. The Q2 collision cell 178 further includes a pressurized compartment that can be maintained at a given pressure (e.g., in a range of about 1 mTorr to about 10 mTorr, though other pressures can also be used for this or other purposes). The fragment ions 174 entering the collision cell 178 undergo collisions with the buffer gas molecules that lead to cooling of the fragment ions 174. The fragment ions 174 continue propagating in the direction of arrow 108 and exit the collision cell 178 via passage through an aperture of a lens 184.

The mass spectrometer 100 further includes a mass analyzer 186 (e.g., a time-of-flight (TOF) analyzer or another type of mass analyzer) positioned downstream from the collision cell 178 that receives the fragment ions 174 and provides mass spectral data associated with the fragment ions 174. An analysis module 188 receives the mass spectral data generated by the mass analyzer 186 and processes the data to generate a mass spectrum of the fragment ions 174 and correlates the mass spectrum of the fragment ions 174 with precursor ions 104 from which the fragment ions 174 were generated.

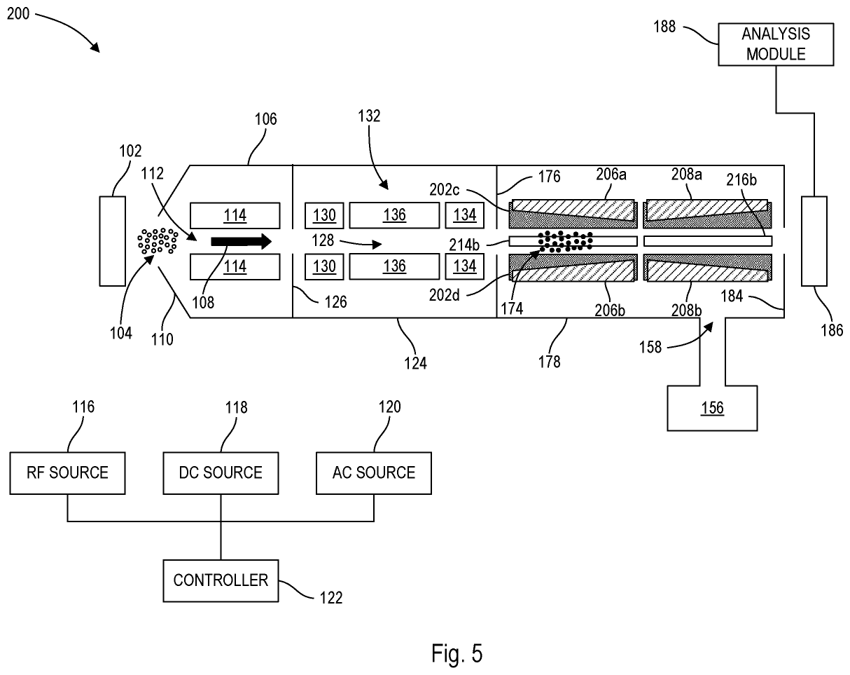

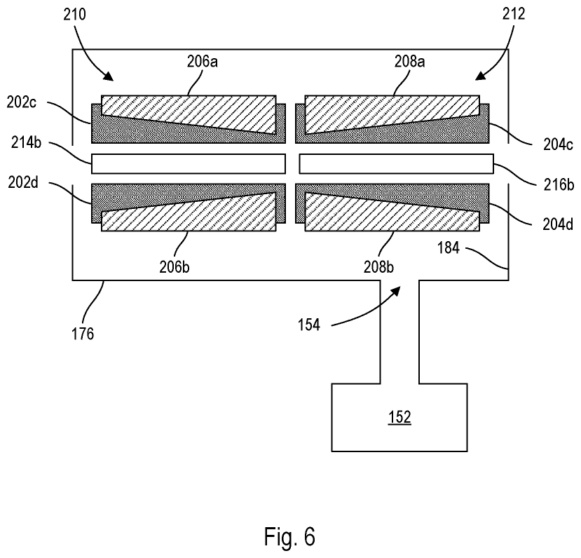

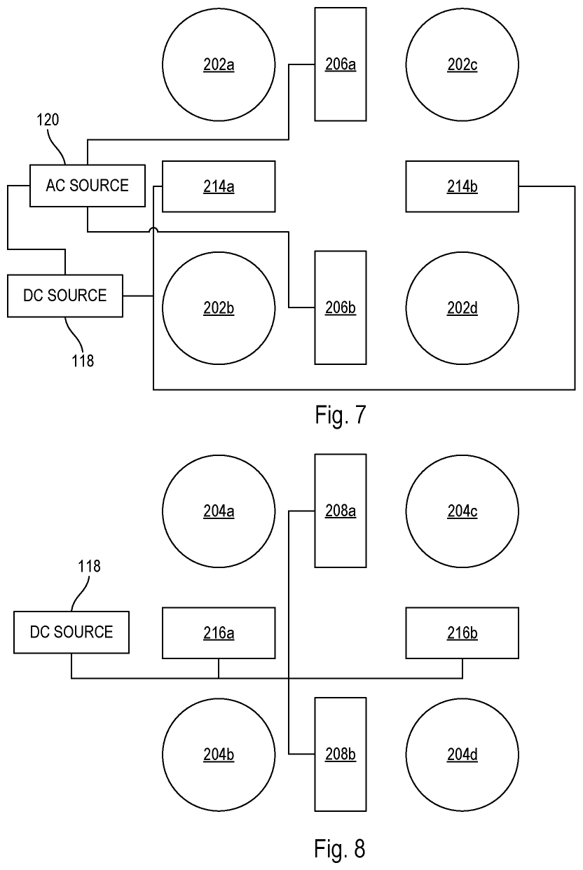

Referring now to FIGS. 5-8 a mass spectrometer 200 is shown in accordance with an exemplary embodiment. The mass spectrometer 200 includes the same elements as the mass spectrometer 100 and as such, like elements have been represented using like reference numerals. The mass spectrometer 200 does not include the resonant ion dissociation device 138. Accordingly, the Q2 collision cell 178 is in communication with the vacuum chamber 124.

In this embodiment, the Q2 collision cell 178 includes a first set of rods including four rods 202a-d, a second set of rods including four rods 204a-d, a first set of linear accelerators including two linear accelerators 206a and 206b, and a second set of linear accelerators including two linear accelerators 208a and 208b. The first set of rods 202 and the first set of linear accelerators 206 define a Q2_1 region 210 whereas the second set of rods 204 and the second set of linear accelerators 206 define a Q2_2 region 212. The collision cell 178 further includes a first set of electrodes including electrodes 214a and 214b and a second set of electrodes including electrodes 216a and 216b.

In this embodiment, the linear accelerator 206a is disposed within a gap between rods 202a and 202c and the accelerator 206b is disposed within a gap between rods 202b and 202d. The linear accelerator 208a is disposed within a gap between rods 204a and 204c and the accelerator 208b is disposed within a gap between rods 204b and 204d. Furthermore, the electrode 214a is disposed within a gap between rods 202a and 202b and the electrode 214b is disposed within a gap between rods 202c and 202d. Also, the electrode 216a is disposed within a gap between rods 204a and 204b and the electrode 216b is disposed within a gap between rods 204c and 204d.

The DC voltage source 134 supplies a DC voltage to the rods 202 and the rods 204 such that the Q2_1 region 210 has a lower bias than the Q2_2 region 212, which results in trapping the precursor ions 104 in the Q2_1 region 210.

Furthermore, the AC voltage source 120 applies a resonant AC voltage to the linear accelerators 206 in a dipolar manner. As previously discussed herein, when the frequency of the AC field is matched to the secular frequency of a precursor ion 104 in the linear quadrupole 202, the precursor ions 104 begin to resonantly oscillate. The oscillating ions collide with molecules of the buffer gas disposed within the Q2 collision cell 178. Since the resonantly excited ions have a higher kinetic energy, they are likely to fragment during collisions with the buffer gas molecules.

The DC voltage source 118 supplies a DC voltage to make the DC potential of the 206 and 214 the same as the quadrupole electrodes 202. The DC voltage source 118 also supplies a DC voltage to make the DC potential of the 208 and 216 negative relative to the electrode 206 and 214. This DC bias configuration traps the precursor ions in the space between the first set of electrodes including electrodes 202, 206 and 214.

The fragment ions 174 continue to propagate in the direction of arrow 108 and exit the collision cell 178 via an aperture of a lens 184. The mass spectrometer 100 further includes a mass analyzer 186 (e.g., a time-of-flight (TOF) analyzer or another type of mass analyzer) positioned downstream from the collision cell 178 that receives the fragment ions 174 and generates mass spectral data associated with the fragment ions 174. An analysis module 188 receives the mass spectral data generated by the mass analyzer and processes the data to generate a mass spectrum of the fragment ions 174 and correlates the mass spectrum of the fragment ions 174 with negatively precursor ions 104 from which the fragment ions 177 were generated.

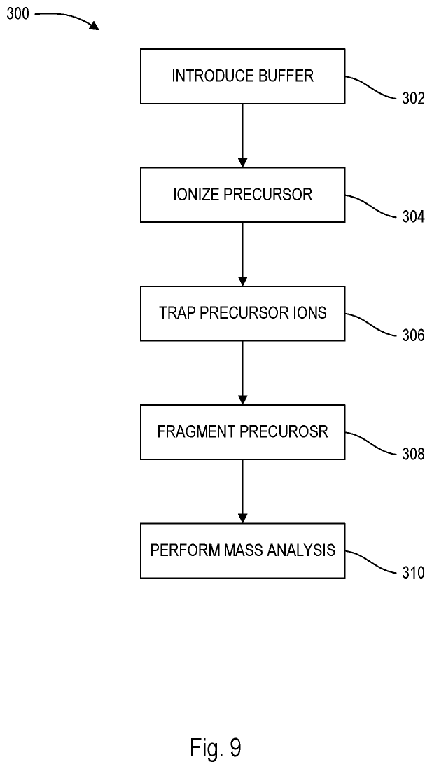

With reference to FIG. 9, a method 300 according to an embodiment of the present teachings for dissociating an oligonucleotide in a mass spectrometer is depicted

At 302, a buffer gas is introduced into an ion trap as previously discussed herein.

At 304, a precursor is ionized to generate precursor ions as previously discussed herein. In some embodiments, the precursor ion is an oligonucleotide having between 5 and 50 nucleotides, e.g., between 10 and 40 or between 20 and 30 nucleotides, or more than 50 nucleotides.

At 306, the precursor ions are trapped within a linear RF quadrupole ion trap portion as previously discussed herein.

At 308, a resonant AC excitation signal resonantly excites the trapped precursor ions (or a selected subset thereof) at secular frequencies thereof to cause selective fragmentation of at least a portion of the precursor ions via CID due to collisions with molecules of the buffer gas as previously discussed herein. The AC excitation signal may be applied during or after the precursor ions are introduced into the ion trap.

At 310, a mass analyzer receives the fragment ions and generates mass spectral data corresponding to m/z ratios of the ions as previously discussed herein. Furthermore, at 310, an analysis module receives the mass spectral data generated by the mass analyzer and processes the data to generate a mass spectrum of the fragment ions and correlates the mass spectrum of the fragment ions with negatively charged precursor ions from which the fragment ions were generated as previously discussed herein.

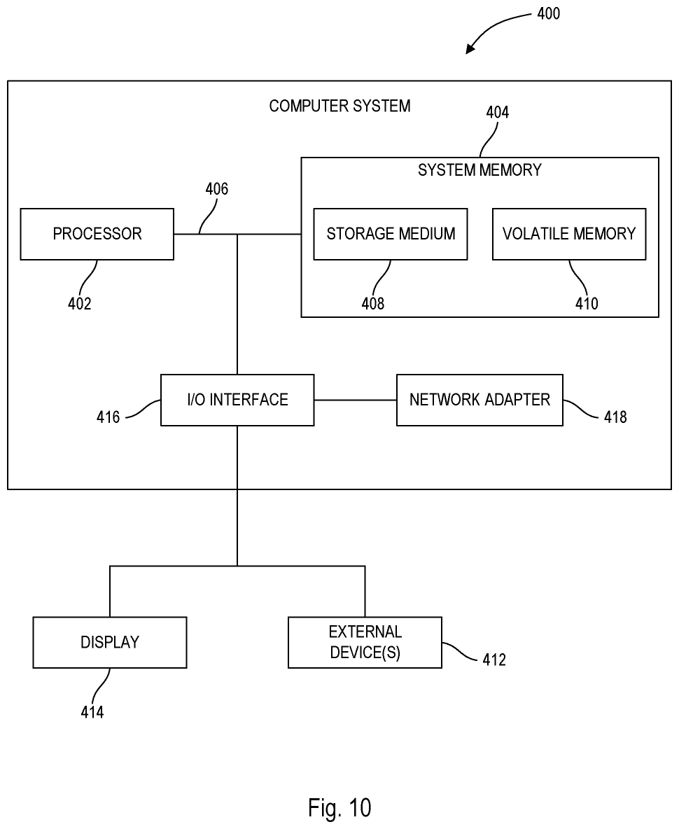

Referring now to FIG. 10, a computer system 400 is shown in accordance with an exemplary embodiment. In some embodiments, the computer system 400 serves as the controller 122.

As used herein a computer system (or device) is any system/device capable of receiving, processing, and/or sending data. Examples of computer systems include, but are not limited to personal computers, servers, hand-held computing devices, tablets, smart phones, multiprocessor-based systems, mainframe computer systems, and distributed cloud computing environments that include any of the above systems and the like

As shown in FIG. 10, the computer system 400 includes one or more processors or processing units 402, a system memory 404, and a bus 406 that couples various components of the computer system 400 including the system memory 404 to the processor 402.

The system memory 404 includes a computer readable storage medium 408 and volatile memory 410 (e.g., Random Access Memory, cache, etc.). As used herein, a computer readable storage medium includes any media that is capable of storing computer readable program instructions and is accessible by a computer system. The computer readable storage medium 408 includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the computer system 400) to function in a particular manner such that a computer readable storage medium (e.g., the computer readable storage medium 408) comprises an article of manufacture. Specifically, when the computer readable program instructions stored in the computer readable storage medium 408 are executed by the processor 402, they create means for implementing various functions described herein.

The bus 406 may be one or more of any type of bus structure capable of transmitting data between components of the computer system 400 (e.g., a memory bus, a memory controller, a peripheral bus, an accelerated graphics port, etc.).

In some embodiments, as depicted in FIG. 10, the computer system 400 may include one or more external devices 412 and a display 414. As used herein, an external device includes any device that allows a user to interact with a computer system (e.g., mouse, keyboard, touch screen, etc.). An external device 412 and the display 414 are in communication with the processor 402 and the system memory 404 via an Input/Output (I/O) interface 416.

The display 414 may show a graphical user interface (GUI) that may include a plurality of selectable icons and/or editable fields. A user may use an external device 412 (e.g., a mouse) to select one or more icons and/or edit one or more editable fields. Selecting an icon and/or editing a field may cause the processor 402 to execute computer readable program instructions stored in the computer readable storage medium 408. In one example, a user may use an external device 412 to interact with the computer system 400 and cause the processor 402 to execute computer readable program instructions relating to the various functions described herein.

The computer system 400 may further include a network adapter 418 which allows the computer system 400 to communicate with one or more other computer systems/devices via one or more networks (e.g., a local area network (LAN), a wide area network (WAN), a public network (the Internet), etc.).

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. A single processor or other processing unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

What is claimed is:

1. A method of dissociation of an oligonucleotide in a mass spectrometer, comprising:
introducing the oligonucleotides into an electrospray ionization source operated in a negative mode to cause deprotonation of said oligonucleotide for generating a negatively charged ion of said oligonucleotides,
trapping said negatively charged oligonucleotide ions in linear radiofrequency (RF) ion traps with T bar electrodes,
filling the linear ion trap with a buffer gas, and
using a resonant dipole AC excitation signal applied to the T bar electrodes to resonantly excite the negatively charged oligonucleotide ions at secular frequencies thereof to cause selective fragmentation of said negatively charged oligonucleotide ions via collision with molecules of said buffer gas.

2. The method of claim 1, wherein said oligonucleotide includes at least five nucleotides.

3. The method of claim 1, wherein said oligonucleotide includes at least 10 nucleotides.

4. The method of claim 1, wherein said oligonucleotide includes at least 15 nucleotides.

5. The method of claim 1, wherein said oligonucleotide includes at least 20 nucleotides.

6. The method of claim 1, wherein said oligonucleotide includes at least 25 nucleotides.

7. The method of claim 1, wherein said oligonucleotide includes at least 30 nucleotides.

8. The method of claim 1, wherein said oligonucleotide includes at least 100 nucleotides.

9. The method of claim 1, wherein said RF ion trap comprises a branched RF ion trap having two sets of four L-shaped electrodes positioned relative to one another so as to provide a longitudinal branch and a transverse branch extending, respectively, along a longitudinal and a transverse axis, and the resonant CID collision with the molecules of said buffer gas is applied to the precursor ions in one or more branch portions.

10. The method of claim 9, wherein said RF ion trap further comprises a pair of opposed T-bar electrodes that is positioned between said L-shaped electrodes along one of the longitudinal and the transverse axis and to which a DC negative voltage is applied to bias the oligonucleotide ion to the channel positioned along the other axis, and wherein a dipolar AC voltage is applied to the L-shaped electrodes so as to generate said resonant dipole AC excitation signal within the channel into which the oligonucleotide ions is biased.

11. The method of claim 9, wherein said RF ion trap further comprises a first pair and a second pair of opposed T-bar electrodes, wherein each pair is positioned between said L-shaped electrodes such that one pair extends along the longitudinal axis and the other pair extends along the transverse axis, wherein a DC bias voltage is applied to said first pair of T-bar electrodes relative to the L-shaped electrodes with the same polarity as that of the oligonucleotide ion and wherein an AC voltage is applied to the second pair of opposed T-bar electrodes in a dipolar manner to generate said resonant dipole AC excitation signal and no DC bias voltage is applied to the second pair of the T-bar electrodes.

12. The method of claim 1, wherein said resonant dipole AC excitation signal is applied during introduction of the oligonucleotide ion into said RF ion trap.

13. The method of claim 1, wherein said resonant dipole AC excitation signal is applied after introduction of the oligonucleotide ion into said RF ion trap.

14. The method of claim 1, wherein a frequency and an amplitude of RF voltages applied to said ion trap are configured to allow trapping ions with m/z ratios within a target range containing the m/z ratio of said oligonucleotide ion and wherein said resonant dipole AC excitation signal has a frequency that matches a secular frequency of said trapped oligonucleotide ion.

15. (canceled)

16. (canceled)

17. A resonant ion dissociation device, comprising:
a chamber, comprising:
a buffer gas,
a plurality of rods arranged in a multipole configuration to generate a linear passageway therebetween extending from an inlet for receiving a plurality of precursor ions to an outlet through which fragments of said precursor ions can exit the passageway, wherein said rods are configured for application of RF voltages thereto, and
a pair of opposed T-bar electrodes positioned between said rods such that application of a resonant AC voltage across said T-bar electrodes generates a resonant excitation AC signal for resonantly exciting at least a portion of said precursor ions so as to cause selective fragmentation thereof via collision with molecules of said buffer gas,
wherein said multipole configuration comprises a linear quadrupole configuration.

18. A mass spectrometer, comprising:
an ion source for receiving a sample and ionizing one or more analytes of the sample to generate a plurality of analyte ions,
a mass filter positioned downstream of said ion source for receiving said analyte ions and selecting a portion of said ions having m/z ratios in a target range as a plurality of precursor ions,
a resonant ion dissociation device positioned downstream of said mass filter to receive said precursor ions and causing resonant excitation of the precursor ions to cause fragmentation thereof via collision with a buffer gas contained within said ion dissociation device, and
mass analyzer positioned downstream of said resonant ion dissociation device for receiving said fragment ions and generating mass spectral data associated with said fragment ions,
wherein said resonant ion dissociation device comprises:
a chamber, comprising:
a buffer gas,
a plurality of rods arranged in a multipole configuration to generate a linear passageway therebetween extending from an inlet for receiving a plurality of precursor ions to an outlet through which fragments of said precursor ions can exit the passageway, wherein said rods are configured for application of RF voltages thereto,
a pair of opposed T-bar electrodes positioned between said rods such that application of a resonant AC voltage across said T-bar generates a resonant excitation AC signal for resonantly exciting at least a portion of said precursor ions so as to cause selective fragmentation thereof via collision with molecules of said buffer gas,
wherein said ion source comprises an electrospray ion source and an RF voltage source for generating RF voltages for application to said multipole rods.

19. (canceled)

20. The mass spectrometer of claim 18, further comprising an RF voltage source for generating said RF voltages and a DC voltage source for generating said DC bias voltage.
